(19) United States
(12) Patent Application Publication
(10) Pub. No.: US 2005/0069860 A1
(43) Pub. Date: Mar. 31, 2005

(54) Interactive child-development education

(76) Inventors: Sean Thomas Clark, Cincinnati, OH (US); Derek Keith Friedman, Maple Valley, WA (US); Tamara Ann Cahill, Ft. Mitchell, KY (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/687,130

(22) Filed: Oct. 16, 2003

Related U.S. Application Data
(60) Provisional application No. 60/484,889, filed on Jul. 3, 2003.

(51) Int. Cl. G09B 19/00

(52) U.S. Cl. 434/433

(57) ABSTRACT

Child development educational displays are disclosed. The educational apparatus disclosed herein may be mobile and may include one or more three dimensional interactive educational aides demonstrating an aspect of child development to a user. An educational apparatus may be located within the trailer of a truck, or may be located within a tent, or other moveable, structure. The structure may have two or more areas wherein each area contains materials which teach a user about one of a plurality of stages of baby or childhood development.

### CROSS REFERENCE TO RELATED APPLICATION

This application claims the benefit of the U.S. Provisional Application No. 60/484,889 filed Jul. 3, 2003.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates to an interactive aide used to educate members of the public about childhood development. In particular, the aide may be three dimensional and mobile.

### BACKGROUND OF THE INVENTION

It has long been appreciated that the development of babies and young children is a complex, multi-faceted, and fascinating process. It has also been appreciated that members of the public, and parents in particular, have an interest in learning more information about the development of babies and young children and about the various aspects of this development. Much of the information provided to date to members of the public, and parents in particular, has been through books, classroom lectures, the internet, and audio-visual material. While such material is quite good and informative, it is often rather clinical and is rarely interactive.

Manufacturers of products designed for babies often conduct extensive research involving the growth and development of babies in order to design better products. Consequently, these manufacturers have valuable and useful information regarding babies and young children, as well as their characteristics, development patterns, and the like.

Additionally, It has been found during development of the present invention that manufacturers of products for babies often have great expertise in marketing to members of the general public, particularly parents of young children, and have some insight as to how to communicate information to such members of the public in a manner that is informative, fun, and easy to remember. In these respects, such information communication offers some advantages over the clinical and non-interactive information typically provided to the public, and parents in particular, regarding topics of interest to them, such as the development of babies and small children. It has also been found during the development of the present invention that members of the public also appreciate receiving information regarding the development of babies and young children in a fun, interactive, and not overly clinical format.

There are many aspects to the development of babies and young children. Some examples include the physical and physiological development of babies and young children, the emotional development of babies and young children, and the psychological development of babies and young children. While any of these facets and others is suited for application in the present invention, the physical and physiological development of babies is a particularly good aspect of the development for education to members of the public using apparatus and methods according the present invention.

It has been known that learning is often more effective when it is interactive, when it involves the people being taught, and when it is interesting and memorable. The apparatus and methods of the present invention are designed to assist members of the public and parents in particular in learning about the development of babies and young children in a new manner which is more effective than previous methods by focusing on the aspects of interactivity and participation.

Previous attempts at providing interactive learning tools to parents and the public regarding childhood development have included the use of internet-based applications. For example, interactive applications on web sites such as www.pampers.com by The Procter & Gamble Company of Cincinnati, Ohio, have used pictures and activities (such as trying to “feed” a picture of a baby using the mouse) to demonstrate the development of vision and motor coordination of babies at various stages of development. These previous attempts, however, were not three-dimensional and were limited by the constraints of the medium. Some “props” have been described in the prior art that are designed to show the relationship of babies and small children to typical items seen in houses such as furniture. For example, the prior art describes oversize tables and chairs designed to show an adult the size relationship of children of a given age to such common items of furniture. These props, however, while sometimes three-dimensional have not typically been interactive, and have not been employed in combination to allow users to learn about or experience multiple stages of childhood development. The present invention uses three-dimensional interactive aides in combination to create a series of powerful, fun, and informative educational tools.

### SUMMARY OF THE INVENTION

In one embodiment, the present invention may be directed to an educational apparatus, or display, comprising a structure divided into two or more areas. The structure may comprise at least a first area and a second area. The structure may have a first three dimensional interactive educational aide, and a second three dimensional interactive educational aide. Each of said first and second interactive educational aides is adapted to provide information regarding an aspect of child development.

The first three dimensional interactive educational aide of the apparatus may be located in the first area and the second three dimensional interactive educational aide may be located in the second area.

The first interactive educational aide may be adapted to provide information regarding an aspect of child development pertaining to a first stage of said development. The second interactive educational aide may be adapted to provide information regarding an aspect of child development pertaining to a second, different stage of development.

The first interactive educational aide may provide information regarding a first aspect of child development wherein said first aspect is chosen from the group consisting of physical development, motor skills, emotional development, sensory development, and coordination. The second interactive aide may provide information regarding a second aspect of child development wherein said second aspect is chosen from the group consisting of physical development, motor skills, emotional development, sensory development, and coordination.

The structure may be movable, it may be capable of being placed into a portable configuration, and it may also be mobile. Additionally, the structure may comprise a tent or a trailer, or it may be self-contained.

The structure may be divided into at least four areas, in which case the structure may comprise at least a first area, a second area, a third area, and a fourth area. In such an embodiment, the first area may be adapted to provide information regarding a first baby stage of development wherein such first stage of development pertains to babies ranging from birth but prior to being able to crawl or walk. The second area may be adapted to provide information regarding a second baby stage of development wherein said second stage of development pertains to babies who are able to crawl or walk for short distances. The third area may be adapted to provide information regarding a third stage of development wherein said third stage of development pertains to children who are able to walk and are learning to run. And the fourth area may be adapted to provide information regarding a fourth stage of development wherein said fourth stage pertains to children who are able to run and are able, at least partially, to dress or undress themselves.

In another embodiment, the present invention may comprise an educational apparatus comprising two or more three dimensional interactive educational aides, wherein said three dimensional interactive educational aides are related by common labeling, indicia, or other insignia. And another embodiment of the present invention may include an educational apparatus comprising a structure divided into two or more areas wherein said structure comprises at least a first area and a second area and wherein each of said first area and said second area contains at least one three dimensional teaching aide adapted to provide information regarding an aspect of child development. At least one of the three dimensional teaching aides in such an embodiment may comprise interactive aides. At least one of the three dimensional teaching aides in such an embodiment may comprise oversized furniture adapted to demonstrate to an adult the relative size of such furniture from a baby's perspective.

The present invention is also directed towards a method of educating a user about child development. In one embodiment, the method may include the step of preparing a structure divided into two or more areas; the structure may comprise at least a first area and a second area. The method additionally may include the step of displaying at least one three dimensional interactive teaching aide in each of said areas; each of the three dimensional interactive teaching aides are adapted to provide information regarding an aspect of child development. And furthermore, the method may include the step of conducting a user through said areas to interact with said three dimensional interactive teaching aides. In this embodiment of the method, the three dimensional interactive teaching aides in each of the areas may be adapted to provide information pertaining to a different stage of child development. Additionally, it should be noted that at least one of the three dimensional interactive teaching aides may provide information to the user in both audible and visible formats.

Another embodiment of the method includes the step of displaying two or more three dimensional interactive teaching aides, wherein said three dimensional interactive teaching aides are adapted to provide information regarding an aspect of child development. The method further includes the step of relating the three dimensional interactive teaching aides by common labeling, indicia, or other insignia. And the method also includes the step of allowing a user to interact with the three dimensional interactive teaching aides. As with the embodiment of the method previously described, each of the two or more three dimensional interactive teaching aides may be adapted to provide information pertaining to a different stage of child development and at least one of the three dimensional interactive teaching aides may provide information to the user in both audible and visible formats.

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawings, in which:

FIG. 1 is view of a tractor-trailer showing a mobile example of an interactive apparatus according to the present invention in its portable state.

FIG. 2 is a view an interactivity apparatus according to the present invention in its assembled ready to use state.

FIG. 3 is a view of a portion of an apparatus according to the present invention showing one of a plurality of stages of childhood development.

FIG. 4 is a view of a portion of an apparatus according to the present invention showing a second of a plurality of stages of childhood development.

FIG. 5 is a view of a portion of an apparatus according to the present invention showing an example of a portion of a second of a plurality of stages of childhood development.

FIG. 6 is a view of a portion of an apparatus according to the present invention showing a third of a plurality of stages of childhood development.

FIG. 7 is a view of a portion of an apparatus according to the present invention showing a fourth of a plurality of stages of childhood development.

### DETAILED DESCRIPTION OF THE INVENTION

The present invention relates to interactive aides and methods used to educate members of the public about childhood development. While parents and especially parents of babies and young children may be a preferred audience, the present invention is not necessarily limited to such groups as the general public may also benefit from the present invention. The apparatus of the present invention may be mobile. By the term “mobile” it is meant that the apparatus is designed to be transported either with or without some degree of packing or unpacking from one location to another. In other words, a mobile apparatus is one which can be placed in a portable configuration. While such mobility offers certain advantages, it is also not a requirement of the present invention. For example, the educational apparatus may also be merely movable, meaning that it can be moved even if such movement requires the use of supplemental equipment such as forklifts, cranes, trucks, or trains.

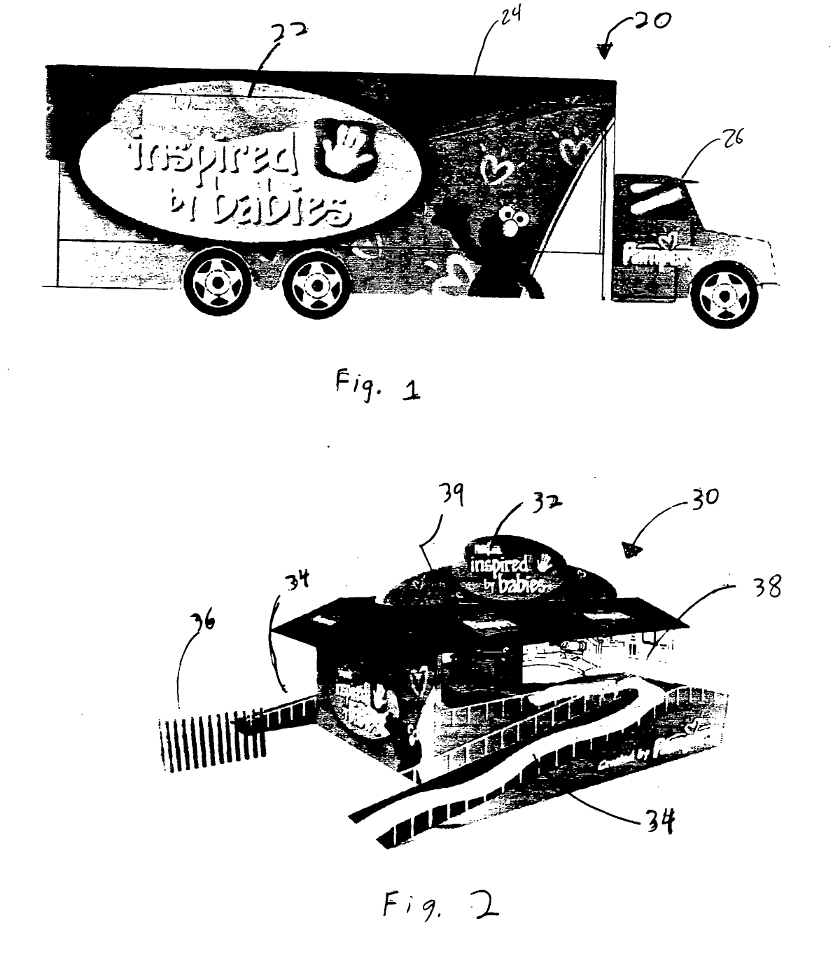

FIG. 1 shows one example of a mobile apparatus according to the present invention. Generally, FIG. 1 shows truck 20 in which the mobile apparatus is located in the trailer 24 behind the cab 26 of the truck 20. Smaller versions of mobile apparatus of the present invention could be made mobile by use of a smaller truck or other vehicle, or could be moved through such means as disassembly and packaging. Additionally, larger versions of the educational apparatus of the present invention may be made mobile by using several trucks 20 and cooperatively associating the trailers 24 of each truck to form the apparatus. It is not necessary that the interactive aides of the present invention be mobile, but it may be desirable. Interactive aides and other apparatus of the present invention may be set up in a somewhat permanent form or in a not easily moved formed. In other embodiments, it is possible to have self-contained interactive aides which may easily be moved such as by carrying, wheeling, use of fork-lifts, or any other suitable method. A tent may also be used to create a mobile structure especially if the tent can be folded and packed into one or more transport containers.

Use of a truck, such as truck 20 shown in FIG. 1 allows interactive aides and apparatus of the present invention to be easily transported from location to location allowing for the educational demonstrations contained therein to be seen by large numbers of people. For example truck 20 can be driven to such locations as large retail stores (such as in the parking lot) or other locations where members of the public (and in particular parents and families) are expected to present. Such locations might include state or county fairs, amusement parks, town squares, festivals, and the like. It may be desired if a mobile apparatus is employed such as truck 20 to put indicia, such as indicia 22 in a visible location on the transportation packaging. These indicia 22 could give some indication of what is inside the truck 20 or other shipping container or may be a “teaser” type slogan. Such indicia 22 may generate interest in the truck 20 or other type of transportation container as it is being driven to its destination and as the interactive aides are being assembled for use.

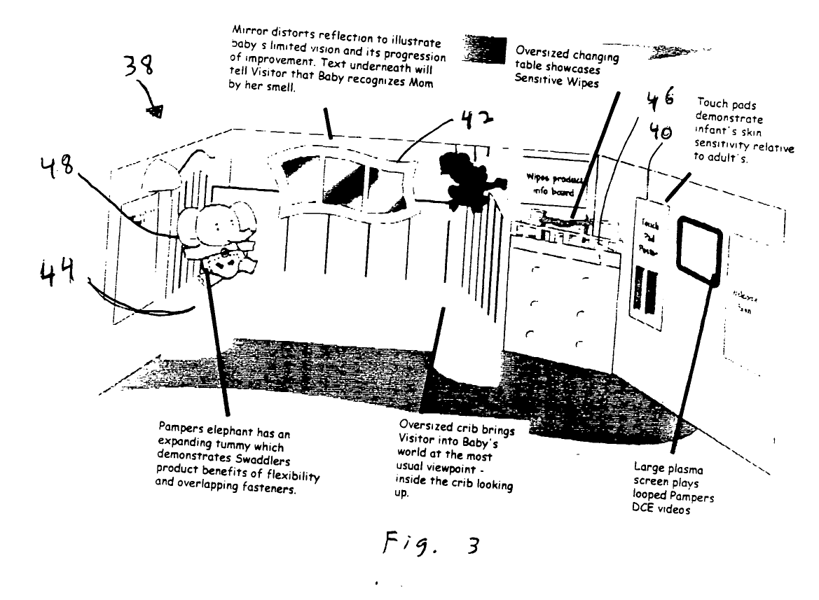

FIG. 2 shows one example of an educational apparatus 30 of the present invention assembled in its ready to use condition. In this case, FIG. 2 represents educational apparatus 30 which was contained within the trailer portion 24 of truck 20 shown in FIG. 1. Of course, it is not necessary that this particular relationship be the case. As shown in FIG. 2, the tractor of truck 20 has been removed, and the trailer has been “converted” into educational apparatus 30. Alternatively, if the truck is not of the tractor trailer type, the cab may remain attached even when the educational apparatus 30 is in its deployed formation. As yet another alternative, more than one trailer 24 can be cooperatively associated to form a larger educational apparatus 30. For example, three or more such trailers may be positioned in a U-shaped formation. The overall educational apparatus 30 may be most any size desired. By way of example, the educational apparatus 30 shown in FIG. 2 in an assembled or unfolded state may be about 14 meters by 13.5 meters in area. Apparatus of this size in a disassembled, folded or portable state can fit on a trailer of truck such as truck 20 of FIG. 1 having a length of approximately 30 feet (9.1 meters).

One of ordinary skill in the art will recognize that through the use of multiple trailers or multiple structures the overall size of the education apparatus can be varied to meet the demands of usage conditions, from very small with a smaller trailer or structure to very large by associating more than one structure or trailer. By way of example, FIG. 8 shows an educational apparatus 110 within the scope of the present invention. FIG. 8 shows a plurality of trailers or structures 112 arranged in cooperation with supporting structures 114 to form a U-shaped educational apparatus 110. In such an embodiment of the present invention, a courtyard 116 is formed wherein users, and particularly families, can interact and ask questions to enhance their learning. Additionally, product samples or additional educational opportunities could be provided in this courtyard 116, as well as areas for administering the operation of the educational apparatus 110. The plurality of trailers 112 and supporting structures 114 may provide a larger interactive area, thus providing greater opportunities for the user to interact with a multitude of three dimensional educational aides.

The educational apparatus 30 may be large enough so that members of the public can walk inside of it and so that several people can comfortably fit inside and be exposed to the educational information and interactive aides simultaneously. Additionally, it may be desired to make the overall size of the educational apparatus 30 large so that it draws attention to itself. In the example shown in FIG. 2 signage such as signage 32 may be employed to give viewers an indication of what the educational apparatus 30 is and to allow people in a crowd to see the educational apparatus 30. As a non-limiting example, the height of the overall education apparatus 30 with such signage 32 as shown in FIG. 2 may be about 8 meters tall.

While the apparatus 30 is shown in FIG. 2 as being a structure with an overhead covering supported by two walls, such a configuration is not a requirement of the present invention. For example, the structure may be a tent that incorporates supports rather than walls to support the overhead covering. Alternatively, the structure may be in the form of a wall or other structures used to cooperatively associate the interactive educational aides of the present invention. It is not necessary that the overall apparatus 30 be as large as that described above and shown in FIG. 2. Smaller versions may be used which accomplish the educational objectives of the invention described herein. Additionally, there need not necessarily be a separate structure (such as that shown in FIG. 2) at all. It is possible to practice the present invention by setting aside a given area of an existing location (such as a gymnasium, store floor, grass field, parking lot, or the like) and assembling in combination two or more interactive aides of the present invention in the manner which will be described in more detail below.

FIG. 2 shows an example of an apparatus 30 provided with ramps 34 for wheelchair and stroller accessibility. Additionally, the apparatus 30 may have an adjacent area such as adjacent area 36 which can be fenced or enclosed and can be used as a play area for children, or can be used as an area for providing additional information or literature to persons using the educational aides of the apparatus 30.

The apparatus 30 of the present invention may comprise two or more areas such as first area 38 and second area 39. First area 38 and second area 39 may be physically separated by walls, partitions or the like, but it is not necessary to have any separation. It is desirable that there be at least some visual separation between areas. Such visual separation can be accomplished by partial or complete physical separation, or it can be accomplished by design elements such as color, tape, or decoration changes. As shown in FIG. 2, the first area 38 and second area 39 may be constructed to resemble rooms such as rooms in a house or apartment. Each of first area 38 and second area 39 may contain one or more interactive educational aides relating to baby or childhood development. More detail about such aides will be given below. It is desirable that first area 38 and second area 39 are dedicated to a particular stage or stages of baby or childhood development and the layout and contents of the area are chosen and adapted to match that particular stage. More details about such representation of stages of development will also be given below.

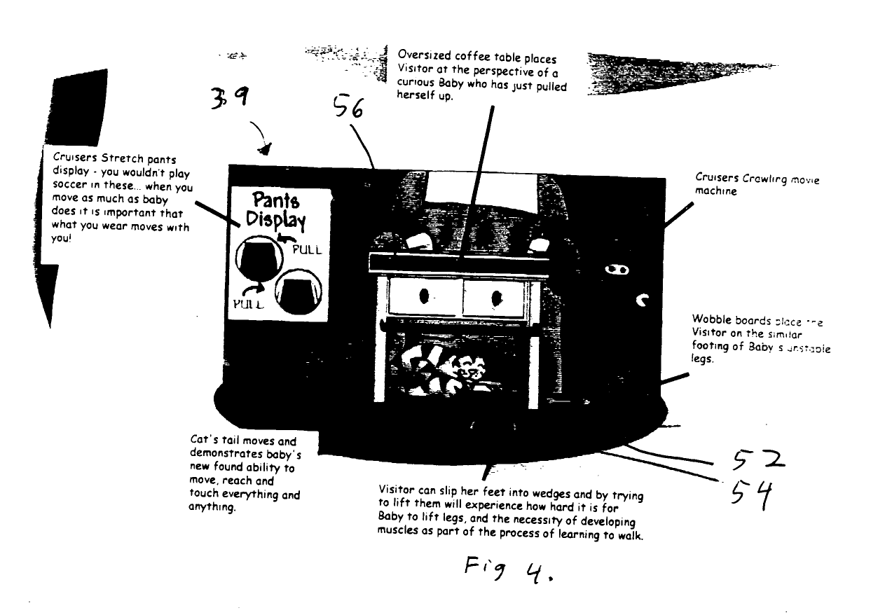

FIG. 3 is a close up view of first area 38 shown in FIG. 2. First area 38 shown in FIG. 3 is designed to resemble a young child's bedroom (or nursery). First area 38 may be provided with one or more interactive educational aides such as interactive touch pads 40 and distorting mirror 42. The items shown and overall design of the “bedroom” shown in FIG. 3 will be described in detail as a mechanism to illustrate aspects of the present invention. It should be understood, however, that the features and aides shown in FIG. 3 are examples only. These features and aides may be varied, modified, or used in different combinations to practice the claimed invention. Not all of the features shown in any of the drawings herein are required to practice the claimed invention.

Ideally, each portion of the overall apparatus, such as first area 38 is adapted to correspond to a particular stage or stages of baby or early childhood development. The stages of development may range from newborns to active toddlers seeking independence. For instance, a first stage of development might cover a pre-locomotive phase and include newborns in a bonding stage with mom and other immobile infants whose level of activity might include a little more than head raising or rolling over. A second stage of development might cover a discovering stage comprising a crawling phase and include curious toddlers developing activity in the form of sitting and mobility in the form of scooting, rolling and crawling. A third stage of development might cover an exploring stage comprising a walking phase and include toddlers whose level of activity includes standing, walking and beginning to run. A fourth stage of development might cover a learning phase and include toddlers capable of doing things by themselves such as dressing and developing coordination which enables them to walk and run without losing balance. This fourth stage might also focus on training and include toddlers undergoing toilet training, attempting to achieve independence and overall, undergoing a transition from baby to child. Other stages are contemplated, such as pre-birth stages to illustrate the experiences of the baby while still in the womb. These stages are given by way of example only; they can be further sub-divided, for example in to five stages or even more. They can be consolidated into three stages. Older children (such as toddlers) might have more detailed stages associated with various aspects of their development.

By way of example, first area 38 shown in FIG. 3 is adapted to correspond to a first stage of baby development. This stage may be referred to as the “swaddler stage,” the “infant stage,” or by any other suitable descriptive term. In the example shown in FIG. 3 this first stage generally corresponds to babies who are not yet crawling or walking on a regular basis. That is, babies at this stage of development spend much of their time on their backs or stomachs. They may move their arms and legs and roll over, but generally are not able to pull themselves up, crawl, or walk. The age range for this stage will vary somewhat for individual babies, but generally this stage corresponds to babies ranging in age from about 0 to about 14 months.

First area 38 as shown in FIG. 3 may be provided with oversize furniture such as crib demonstration 44. The crib demonstration 44 shown allows adults (such as parents) to hold on to the “railing” of the crib demonstration 44 and get some perspective about what the bedroom looks like looking up from a babies perspective. Ideally, the crib demonstration 44 is sized so that it is about as proportionally big for an average sized adult as a real baby crib would be for an average sized baby at this stage of development. Similarly, other furniture such as changing table and dresser 46 may also be provided. Once again, this furniture may be oversized so that it appears as big to an average sized adult as a typical dresser and changing table would appear to an average sized baby at this stage of development (relative to the size of the baby's body).

As noted earlier, first area 38 may be provided with one or more interactive educational aides. One example of such an interactive educational aide may be distorting mirror 42. In this example, distorting mirror 42 is designed to allow adults (such as parents) to look at their reflection in the mirror and see in a way that simulates the vision of babies at this stage of development (in the example shown in FIG. 3 this is the swaddler or infant stage). Consequently, in the example shown in FIG. 3 distorting mirror 42 is adapted to not reflect images completely accurately, but is provided with distortion to the extent necessary to reflect the actual visual acuity of infants in the 0 to 6 month age range. This gives adults looking into the mirror education into what visual development is like for babies in this stage. Additionally, the mirror educational aide 42 may be configured to comprise more than one individual mirrors. For example, the mirror educational aide 42 shown in FIG. 3 comprises three distinct mirrors. Such an embodiment of the mirror educational aide may be preferred to incorporate mirrors with different levels of distortion to represent the change in a baby's eyesight over time.

The distorting mirror educational aide 42 is just one of many possible examples of an interactive educational aide. As used herein the term “interactive educational aide” refers to any three dimensional device or apparatus which can provide educational information or an educational experience to adults regarding some aspect of the development of babies and young children. This information might relate to physical development, emotional development, or some other aspect of development. By “interactive” it is meant that a user of the educational aide must perform some action or activity upon or with the device. Such action or activity can include touching, looking at, feeling, holding, or manipulating some portion of the device. When this action or activity is performed, the educational aide will provide some reaction, or an experience for the user, which conveys the developmental information to the user. The educational aides of the present invention may be configured to provide educational information and experiences through visual media, audible media, other media that communicates with one or more of the body's senses, or a combination of media. Using these definitions, the distorting mirror 42 is an interactive educational aide because a user must look into it and see his or her reflection. Upon looking into the distorting mirror 42, the mirror will reflect the user's image back with distortion that accurately demonstrates the developing vision of babies at this early stage of development.

Another example of an interactive educational aide might be an interactive touch pad such as interactive touch pad 40. Touch pad 40 such as that shown in FIG. 3 might have samples of materials such as samples of carpeting. A first sample might be unmodified carpeting which demonstrates how such material feels to the touch of an adult. The touch pad 40 may have a second sample of carpeting which is modified to demonstrate to adults the relative sensitivity (to textures, for example) of a baby at this stage of development. It will be readily appreciated that touch pad 40 is an educational interactive aide within the meaning of the definitions provided herein.

In addition to those items already described, first area 38 might be provided with any number of desired other features. These features can include general decoration, welcome signs, posters or placards explaining the various items in the area or providing instructions for use. The first area 38 may also be provided with demonstrations of products for babies at this stage of development. For example stuffed elephant 48 shown in FIG. 3 is a toy elephant with an expanding “tummy region.” The stuffed elephant 48 may be provided with a diaper such as a PAMPERS SWADDLERS® diaper showing how the product fits babies at this stage as their “tummy region” expands and contracts with their movements. Other product usage suggestions could also be provided if desired.

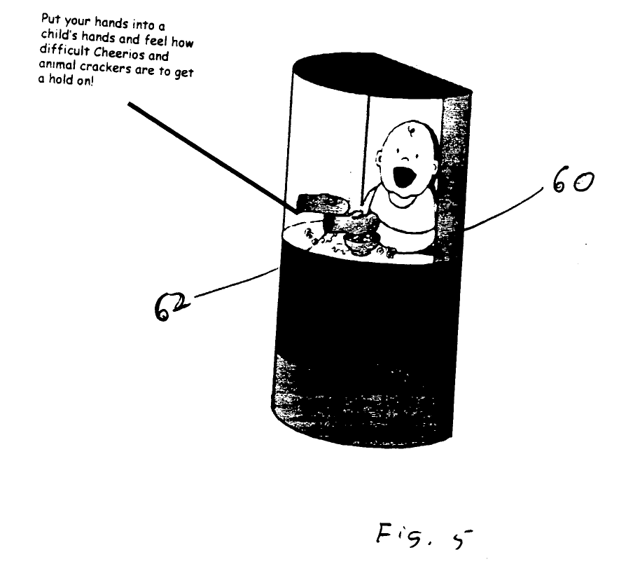

FIG. 4 is a close up view of second area 39 shown in FIG. 2. Second area 39 shown in FIG. 4 is designed to resemble a living room area which might be present in a young child's house or apartment Second area 39 is provided with one or more interactive educational aides such as wabble board 52 and feet wedges 54. The items shown and overall design of the “living room” shown in FIG. 4 will be described in detail as a mechanism to illustrate aspects of the present invention. As noted above with respect to FIG. 3, it should be understood, however, that the features shown in FIG. 4 are examples only. These features may be varied, modified, or used in different combinations to practice the claimed invention. Not all of the features shown in any of the drawings herein are required to practice the claimed invention.

Second area 39 might be adapted to correspond to a second stage of development which may be described as a “cruiser stage.” Babies in this cruiser stage typically may be pulling up onto furniture, may be holding onto furniture while walking, might be crawling, or may be walking upright unassisted for at least short distances. This stage of development might on average describe children ranging in ages from about 10 months to about 18 months in age.

As noted earlier, second area 39 may also provided with one or more interactive educational aides. As one example of interactive educational aides, second area 39 as shown in FIG. 4 may be provided with oversize furniture such as coffee table 56. The coffee table 56 shown allows adults (such as parents) to hold on to the edge and see over the table top from the perspective of a short child. Ideally, the coffee table 56 is sized so that it is about as proportionally big for an average sized adult as a real coffee table would be for an average sized baby at this stage of development. Similarly, other furniture such as a sofa or an easy chair may also be provided. Once again, this furniture may be oversized so that it appears as big to an average sized adult as a sofa or easy chair would appear to an average sized baby at this stage of development (relative to the size of the baby's body).

Another example of such an interactive educational aide may be wobble board 52. In this example, wobble board 52 is designed to allow adults (such as parents) to stand on a somewhat unstable platform to experience the effect of trying to stand with the less developed motor skills and coordination of a baby at this stage of development relative to an adult. This gives adults standing on the wobble board 52 direct sensory feedback and educates adults on the motor skills and coordination development of babies first learning to stand and to walk.

Yet another example of an interactive educational aide which might be provided for this stage of development is feet wedges 54. Feet wedges 54 allow a user to slip his or her feet into them (such as one would put on slippers). The wedges can then be raised from the floor by lifting the legs, but they offer some resistance to lifting. The resistance is tailored to give an adult the experience of a baby, at this stage of development, lifting his or her legs with less developed leg muscles compared to those of an adult.

In addition to those items already described, second area 39 might be provided with any number of desired other features. These features can include any of those items described with respect to first area 38. Product samples such as PAMPERS CRUISERS® diapers can show the importance of a diaper that moves and stretches with an active baby at this stage of development. Other features in second area 39 could include a movie or TV display of babies crawling, and pulling up, oversized “family pets” such as a cat, or general decorations or items expected to be present in a house or apartment with a young child. The movie or TV display may be configured such that the display is interactive. In one embodiment of an interactive movie, the display may be provided with a control device, such as a wheel, and the movie and control device may be associated such that the movie progresses forward or backwards at different speeds depending on the related actions of the control device. In a preferred embodiment, the control device is a wheel that the user spins in one direction to advance the movie and in the opposing direction to reverse the movie; additionally, the speed at which the movie advances or reverses can be controlled by the speed at which the user spins the control wheel.

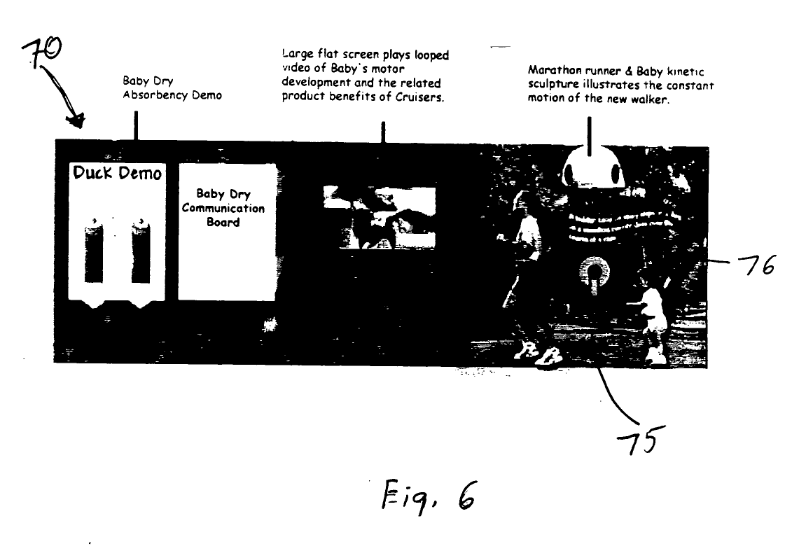

FIG. 5 is an example of an interactive educational aide which may be employed in the present invention. FIG. 5 shows interactive eating display 60. Such a display can be provided as part of a larger area (such as second area 39), or can be a “stand alone” interactive educational aide. An apparatus according to the present invention can be created by such a “stand alone” interactive educational aide employed either alone or in combination with other interactive educational aides. Interactive eating display 60 shown in FIG. 5 generally comprises a pair of hand inserts 62. The interactivity of eating display 60 is experience when the user places his or her hands inside the hand inserts 62. The exterior of the hand inserts 62 may be adapted to confirm only moderately to the users hands. This makes handling of objects (such as pieces of food, crackers, etc.) more difficult as dexterity is thereby reduced. This device allows the user to experience the perspective of a child trying to eat at a stage during which the child's pincer grasp ability is less developed than that of an adult.

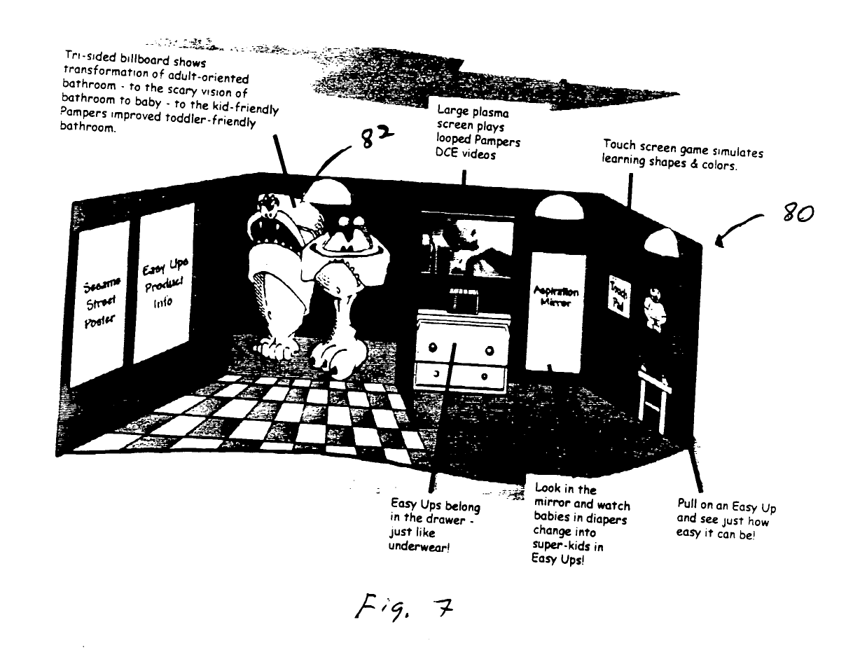

FIG. 6 is an example of a third area 70 which may be provided in the apparatus of the present invention. Third area 70 shown in FIG. 6 is not visible from the view shown of apparatus 30 in FIG. 2. This third area 70 may be adapted to a third stage of baby development. This stage of development might cover an exploring stage comprising a walking phase and include toddlers whose level of activity includes standing, walking and beginning to run. Examples of information which may be provided to users in this stage are shown in FIG. 6. Such examples may include video's, pictures, product demonstrations and the like. This area could also be provided with interactive educational aides adapted to correspond to this stage of development. An example of such an interactive educational aide is runner demonstration 75. Runner demonstration 75 comprises a handle or crank 76 which the users can turn. The images or figures of an adult runner and a child “runner” then move. The runner demonstration 75 shows the user how much more relative movement is required of the child runner to cover the same distance the adult runner covers with fewer steps or strides. This interactive aide provides the user with information regarding how much physical activity is involved in a child's walking or running movements and the flexibility required of baby clothes, diapers, and the like.

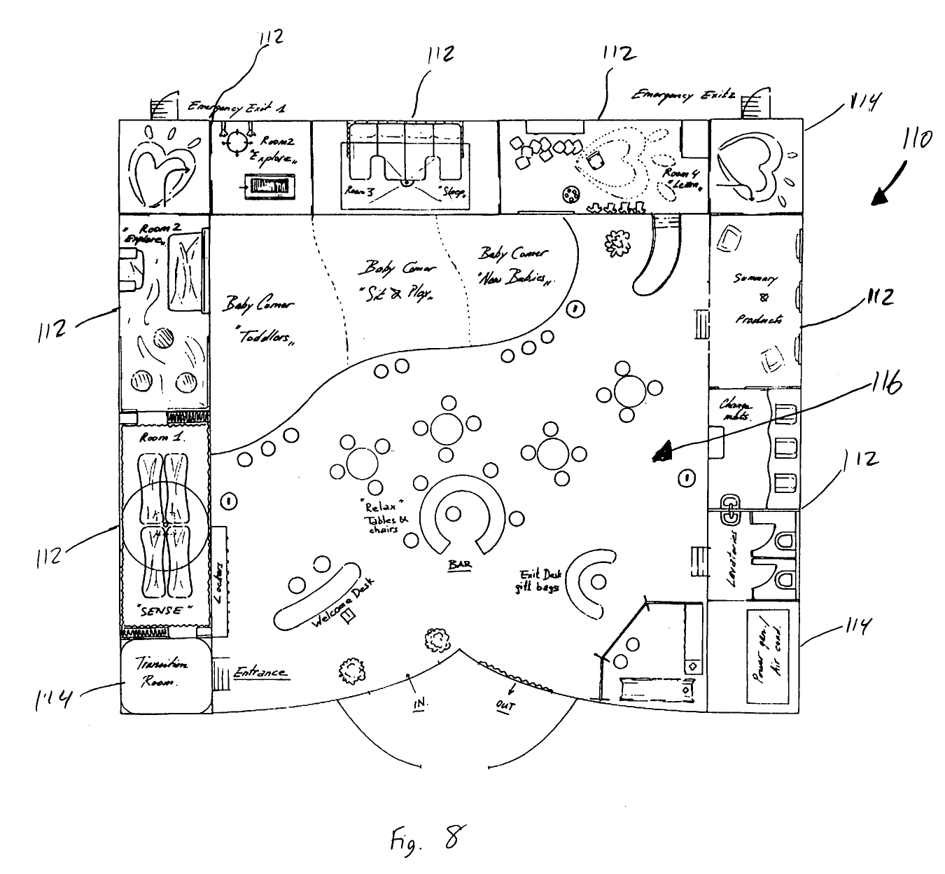

FIG. 7 is an example of a fourth area 80 which may be provided in the apparatus of the present invention. Fourth area 80 shown in FIG. 7 is not visible from the view shown of apparatus 30 in FIG. 2. This fourth area 80 may be adapted to a fourth stage of baby development Such a fourth stage of development might cover a learning phase and include toddlers capable of doing things by themselves such as dressing and developing coordination which enables them to walk and run without losing balance. This fourth stage might also focus on training and include toddlers undergoing toilet training, attempting to achieve independence and overall, undergoing a transition from baby to child. It may be desired, but it is not necessary, to include emotional or psychological development information in fourth area 80. Of course, any of the previous stages can also have such emotional and/or psychological information provided corresponding to that stage as well. In the example shown in FIG. 7, fourth area 80 represents a bathroom and bedroom combination, each of which may be found in the house or apartment of a child in this stage of development. This stage of development may typically correspond to ages ranging from about 18 months to about 48 months.

Fourth area 80 may also be provided with interactive educational aides. An example of such an interactive educational aide is bathroom sink and toilet 82. The sink and toilet 82 shown in FIG. 7 transforms (upon approximating the device, for example) from a conventional sink and toilet to a “scary” or “monster” version. This can be done through projected images, rotating panels, hidden compartments, or any other known means. The adult user is educated on the emotional development of learner stage children who often find the bathroom, particularly using the bathroom, to be a scary experience. A modification of this interactive educational aide could be a “big sink and toilet” and “smaller sink and toilet” display. A first configuration can show how adult size bathroom fixtures appear very oversized to a child first learning how to use the toilet. The display can have a “kid-friendly” configuration in which the fixtures are smaller and more appropriately sized. Other interactive educational aides and features can also be provided. Product samples or information such as samples of or information about products such as PAMPERS EASY UPS® may also be included in fourth area 80.

Any of the areas described above can also be provided with product information pertaining to baby products geared toward a particular stage of development. For example, the first, second, third, and fourth areas described above might each have product information pertaining to disposable diapers specially designed and adapted to children and babies in various stages of development. The product information could include oversize diaper products which highlight features of the product. For example, a display of a diaper that is four times the size of a standard diaper might be useful to show the impact of stretchy sides on the overall ability of the diaper to conform to the body of the baby. Once a user of the apparatus appreciates how much and in what manner a baby in a given stage of development moves, understanding how product features relate to such considerations is valued by consumers.

The above description has focused on the details on one particular embodiment of an apparatus of the present invention which may be employed. All variety of other embodiments may also be used. An apparatus of the present invention can comprise a single three-dimensional interactive educational aide adapted to provide information to a user regarding the development of babies or young children. Any of the examples of such interactive educational aides described herein may be employed “stand-alone” as such an embodiment of the present invention. Additionally, an apparatus of the present invention can comprise two or more such interactive educational aides where each aide is adapted to provide a user with information regarding a different stage of baby or child development. Such multiple interactive aides can be part of a larger structure such as apparatus 30 shown which can be carried by truck 20. Alternatively, there need not be any ancillary structure at all. The multiple interactive aides described can merely be related by common labeling, branding, or other indicia.

As noted, if ancillary structure is provided, it may be permanent or mobile. It may be a simple “booth” display, or a large “walk-through” structure. Even a permanent building or a portion of a building can be used if desired.

A method of the present invention may be practiced by providing to a subject one or more interactive educational aides in accordance with the description contained herein. The method may also comprise a step of allowing a user to use the interactive educational aide to learn information about baby and/or childhood development as described herein.

The present invention offers several distinct advantages over the prior art. Because it is interactive, it is more effective than other methods in teaching information about baby and childhood development to members of the public.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. An educational apparatus comprising:
a. a structure divided into two or more areas wherein said structure comprises at least a first area and a second area,
b. a first three dimensional interactive educational aide,
c. a second three dimensional interactive educational aide,
d. wherein each of said first and second interactive educational aides when used by an adult user provides information directly to said adult user regarding an aspect of child development.

2. The educational apparatus of claim 1 wherein said first three dimensional interactive educational aide is located in said first area and wherein said second three dimensional interactive educational aide is located in said second area.

3. The educational apparatus of claim 1 wherein said first interactive educational aide is adapted to provide information regarding an aspect of child development pertaining to a first stage of said development and wherein said second interactive educational aide is adapted to provide information regarding an aspect of child development pertaining to a second stage of development wherein said first and said second stages of development are different from each other.

4. The educational apparatus of claim 1 wherein said first interactive educational aide provides information regarding a first aspect of child development wherein said first aspect is chosen from the group consisting of physical development, motor skills, emotional development, sensory development, and coordination, and wherein said second interactive aide provides information regarding a second aspect of child development wherein said second aspect is chosen from the group consisting of physical development, motor skills, emotional development sensory development, and coordination.

5. The educational apparatus of claim 1 wherein said structure is movable.

6. The educational apparatus of claim 1 wherein said structure is capable of being placed into a portable configuration.

7. The educational apparatus of claim 1 wherein said structure comprises a tent.

8. The educational apparatus of claim 1 wherein said structure comprises a trailer.

9. The educational apparatus of claim 1 wherein said structure is self-contained.

10. The educational apparatus of claim 1 wherein said structure is divided into at least four areas, wherein said structure comprises at least a first area, a second area, a third area, and a fourth area.

11. The educational apparatus of claim 10 wherein said first area is adapted to provide information regarding a first baby stage of development wherein said first stage of development pertains to babies prior to being able to crawl or walk, said second area is adapted to provide information regarding a second baby stage of development wherein said second stage of development pertains to babies who are able to crawl or walk for short distances, said third area is adapted to provide information regarding a third stage of development wherein said third stage of development pertains to children who are able to walk and are learning to run, and wherein said fourth area is adapted to provide information regarding a fourth stage of development wherein said fourth stage pertains to children who are able to run and arc able at least partially to dress or undress themselves.

12. An educational apparatus comprising two Or more three dimensional interactive educational aides, wherein said three dimensional interactive educational aides are related by common labeling, indicia, or other insignia and wherein said three dimensional interactive educational aides provide information to an adult user relating to an aspect of child development.

13. An educational apparatus comprising:
a. a structure divided into two or more areas wherein said structure comprises at least a first area and a second area,
b. wherein each of said first area and said second area contains at least one three dimensional teaching aide wherein each of said three dimensional teaching aides when used by an adult user provides information regarding an aspect of child development directly to said adult user.

14. The educational apparatus of claim 13 wherein at least one of said three dimensional teaching aides comprises interactive aides.

15. The educational apparatus of claim 13 wherein at least one of said three dimensional teaching aides comprises oversized furniture adapted to demonstrate to an adult the relative size of such furniture from a baby's perspective.

16. A method of educating a user about child development, wherein said method comprises the steps of:
a. preparing a structure divided into two or more areas wherein said structure comprises at least a first area and a second area,
b. displaying a first three dimensional interactive teaching aide in said first area and displaying a second three dimensional interactive teaching aide in said second area, wherein each of said three dimensional interactive teaching aides when used by an adult user provides information regarding an aspect of child development directly to said adult user, and
c. allowing a user to interact with said three dimensional interactive teaching aides.

17. The method of claim 16, wherein the three dimensional interactive teaching aides in each of said areas are adapted to provide information pertaining to a different stage of child development.

18. The method of claim 16, wherein at least one of the three dimensional interactive teaching aides provides information to the user in both audible and visible formats.

19. A method of educating a user about child development, wherein said method comprises the steps of:
a. displaying two or more three dimensional interactive teaching aides, wherein said three dimensional interactive teaching aides when used by an adult user provides information regarding an aspect of child development directly to said adult user;
b. relating said three dimensional interactive teaching aides by common labeling, indicia, or other insignia; and
c. allowing a user to interact with said three dimensional interactive teaching aides.

20. The method of claim 19, wherein each of the two or more three dimensional interactive teaching aides arc adapted to provide information pertaining to a different stage of child development.

21. The method of claim 19, wherein at least one of the three dimensional interactive teaching aides provides information to the user in both audible and visible formats.
